(19) United States
(12) Patent Application Publication
(10) Pub. No.: US 2026/0285142 A1
(43) Pub. Date: Sep. 24, 2026

(54) ELECTRIC VEHICLE

(71) Applicant: TOYOTA JIDOSHA KABUSHIKI KAISHA, Toyota-shi (JP)

(72) Inventor: Koichi NAKAMURA, Miyoshi-shi (JP)

(21) Appl. No.: 19/387,648

(22) Filed: Nov. 13, 2025

(30) Foreign Application Priority Data
Mar. 18, 2025 (JP) 2025-043408

(51) Int. Cl. B60K 7/00; B60K 1/00

(52) U.S. Cl. CPC B60K 7/0007; B60K 2001/001

(57) ABSTRACT

An electric vehicle includes an electric drive unit, a connector of a high-voltage cable, and a side rail of a suspension member. The electric drive unit is mounted at a rear portion of the vehicle and is coupled to a rear wheel via a drive shaft. The connector of the high-voltage cable is connected to a portion of a left side surface of the electric drive unit that is farther toward a rear of the vehicle than the drive shaft is. The side rail of the suspension member is provided between the side surface and the rear wheel. The side rail is configured such that a distance in a vehicle width direction between the side rail and the side surface increases from a portion of the side surface to which the connector is connected toward the rear of the vehicle.

### CROSS-REFERENCE TO RELATED APPLICATIONS

This application is based upon and claims the benefit of priority from Japanese Patent Application No. 2025-043408, filed on March 18, 2025, the entire contents of which are incorporated herein by reference.

### BACKGROUND

### Field

The present disclosure relates to an electric vehicle equipped with an electric drive unit mounted at a rear portion of the vehicle.

### Description of Related Art

JP2006-248313A discloses an electric vehicle in which an electric drive unit, constituted for example by a motor, is mounted in an engine compartment at a front portion of the vehicle. A connector of a high-voltage cable is connected to the electric drive unit of the electric vehicle.

When an electric vehicle including an electric drive unit is repaired or inspected, the connector may need to be detached and reattached. In some electric vehicles, an electric drive unit is mounted at a rear portion of each vehicle. At present, however, the serviceability of connector removal and reattachment in electric vehicles having the electric drive unit mounted at the rear portion has not been sufficiently considered, and there remains room for improvement.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an electric vehicle includes an electric drive unit that is mounted at a rear portion of a vehicle and is coupled to a rear wheel via a drive shaft, a connector of a high-voltage cable connected to a portion of a side surface of the electric drive unit that is farther toward a rear of the vehicle than the drive shaft is, and a side rail of a suspension member provided between the side surface and the rear wheel. The side rail is configured such that a distance in a vehicle width direction between the side rail and the side surface increases from a portion of the side surface to which the connector is connected toward the rear of the vehicle.

Other features and aspects will be apparent from the following detailed description, the drawings, and the claims.

### BRIEF DESCRIPTION OF THE DRAWINGS

FIG. 1 is a diagram schematically showing a configuration of a vehicle rear portion of an electric vehicle according to an embodiment, as viewed from above the vehicle.

FIG. 2 is a diagram schematically showing the configuration of the vehicle rear portion of the electric vehicle according to the embodiment, as viewed from the left side of the vehicle.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

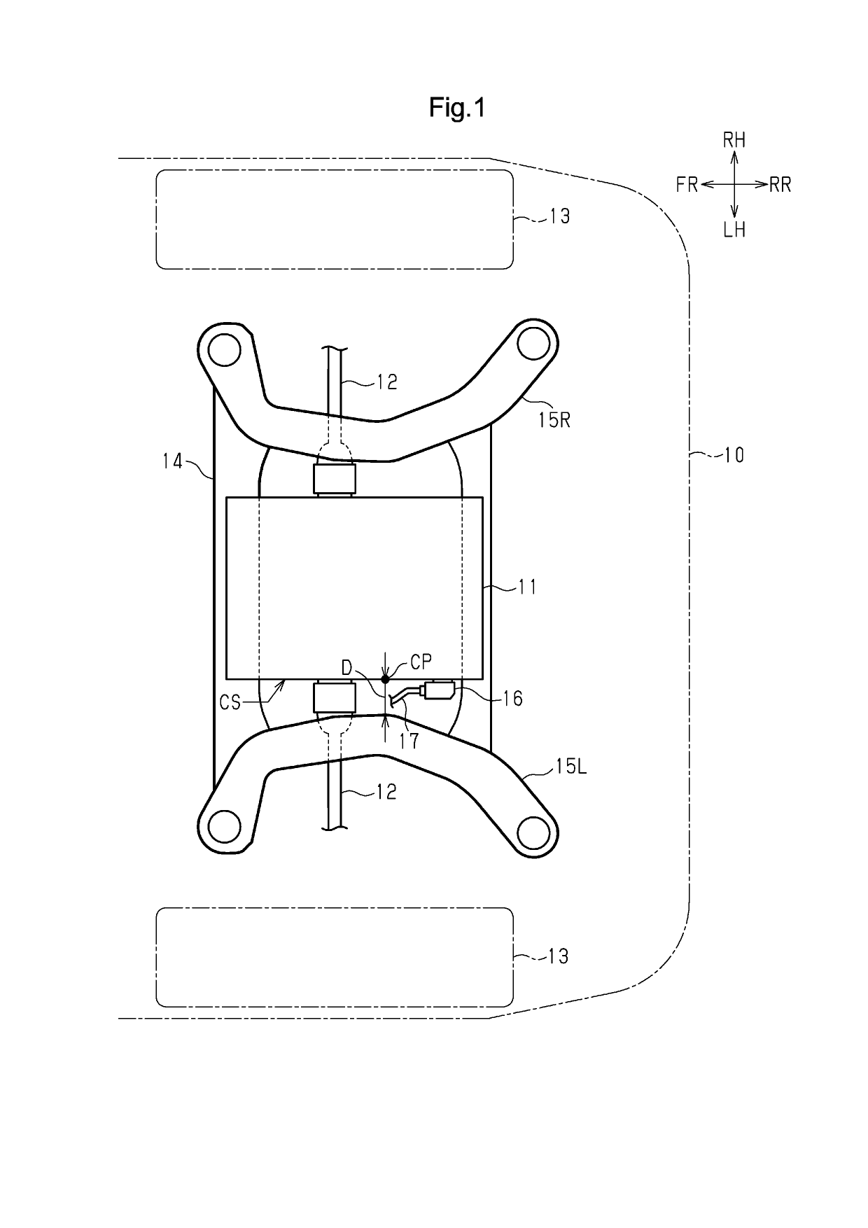

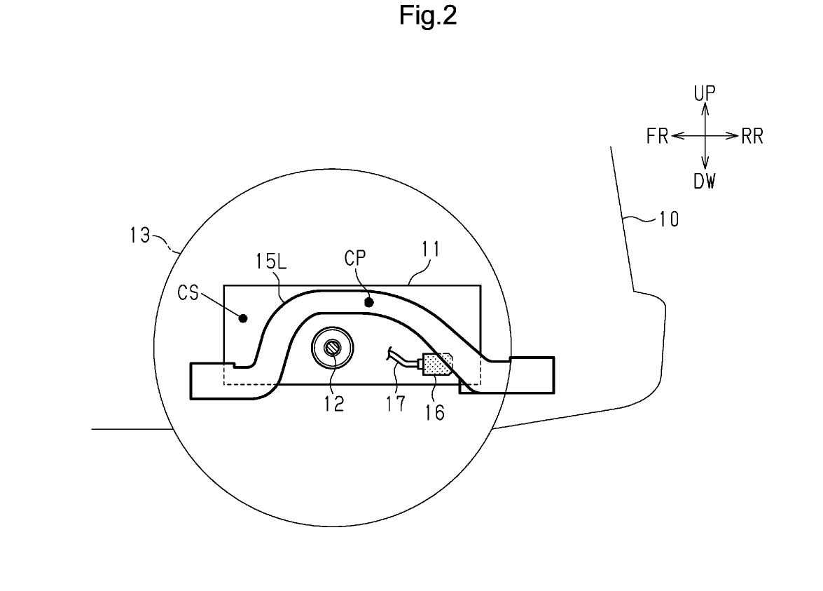

An electric vehicle according to an embodiment will now be described with reference to FIGS. 1 and 2. The electric vehicle 10 of the present embodiment is configured as a battery electric vehicle or a hybrid electric vehicle.

### Configuration of Vehicle Rear Portion of Electric Vehicle

FIG. 1 shows a configuration of a rear portion of an electric vehicle 10 as viewed from above the vehicle 10. FIG. 2 shows a configuration of a vehicle rear portion of the electric vehicle 10 as viewed from the left side of the vehicle 10. An electric drive unit 11 is mounted on a vehicle rear portion of the electric vehicle 10 of the present embodiment. The electric drive unit 11 is a unit that generates a driving force of the electric vehicle 10 by receiving power supply. The electric drive unit 11 in the case of the present embodiment is configured as a unit in which a motor and a speed reduction/differential mechanism are accommodated in one case. The electric drive unit 11 may include an electric device such as an inverter in addition to these components. The electric drive unit 11 is connected to left and right rear wheels 13 via a drive shaft 12.

A suspension member 14 is installed at a vehicle rear portion of the electric vehicle 10. The suspension member 14 is a frame component of the electric vehicle 10 that supports a suspension device of the rear wheel 13. Each of the side rails 15L, 15R is formed in a curved shape so as to have a portion positioned on the vehicle width direction inner side of both end portions in the vehicle front-rear direction.

A connector 16 of a high-voltage cable 17 is connected to a side surface CS of the electric drive unit 11 on the left side in the vehicle 10. The electric drive unit 11 is electrically connected to an inverter or a battery via a high-voltage cable 17. The connector 16 is connected to a portion of the side surface CS of the electric drive unit 11 that is farther toward a rear of the vehicle 10 than the drive shaft 12 is. A left side rail 15L of the suspension member 14 is interposed between the left rear wheel 13 and the side surface CS of the electric drive unit 11 to which the connector 16 is connected. A position CP in the drawing indicates a position at which a distance D in the vehicle width direction with respect to the side rail 15L is minimized on the side surface CS of the electric drive unit 11. A portion of the side rail 15L rearward of the position CP in the vehicle 10 is formed so as to separate from the side surface CS of the electric drive unit 11 as it extends rearward in the vehicle 10. The connector 16 of the high-voltage cable 17 is connected to a portion of the side surface CS of the electric drive unit 11 that is farther toward the rear of the vehicle 10 than the position CP is. That is, the side rail 15L is configured such that the distance D in the vehicle width direction between the side rail 15L and the side surface CS increases from the portion of the side surface CS of the electric drive unit 11 to which the connector 16 is connected toward the rear of the electric vehicle 10.

### Operation of the Embodiment

When the electric vehicle 10 is repaired or inspected, the connector 16 may be attached to or detached from the electric drive unit 11. As described above, the connector 16 is connected to a portion of the left side surface CS of the electric drive unit 11 that is farther toward the rear of the vehicle 10 than the drive shaft 12 is. On the other hand, a left side rail 15L of the suspension member 14 is interposed between the left side surface CS of the electric drive unit 11 and the left rear wheel 13. For this reason, it is necessary to insert a hand into a clearance between the side surface CS of the electric drive unit 11 and the side rail 15L to attach and detach the connector 16.

In the electric vehicle 10 of the present embodiment, the side rail 15L is configured such that the distance D in the vehicle width direction between the side rail 15L and the side surface CS of the electric drive unit 11 increases from the portion to which the connector 16 is connected toward the rear of the vehicle 10. Therefore, it is easy to access the portion to which the connector 16 is connected from the rear of the vehicle 10.

### Advantages of the Embodiment

The electric vehicle 10 of the present embodiment has the following effects.

The connector 16 of the high-voltage cable 17 is connected to a portion of the left side surface CS of the electric drive unit 11 that is farther toward the rear of the vehicle 10 than the drive shaft 12 is. The side rail 15L of the suspension member 14 is interposed between the side surface CS, to which the connector 16 is connected, and the left rear wheel 13. The side rail 15L is configured such that the distance D in the vehicle width direction between the side rail 15L and the side surface CS, to which the connector 16 is connected, increases from the portion of the side surface CS to which the connector 16 is connected toward the rear of the vehicle 10. Therefore, it is easy to access the portion to which the connector 16 is connected from the rear of the vehicle 10. Therefore, the electric vehicle 10 of the present embodiment has an effect of improving the serviceability when the connector 16 of the high-voltage cable 17 is attached to and detached from the electric drive unit 11 mounted on the rear portion of the vehicle 10.

### Other Embodiments

The above-described embodiment may be modified as follows. The above-described embodiment and the following modifications can be combined if the combined modifications remain technically consistent with each other.

The connector 16 may be connected to the right side surface of the electric drive unit 11. In this case, the right side rail 15R of the suspension member 14 is interposed between the right side surface of the electric drive unit 11 to which the connector 16 is connected and the right rear wheel 13. In this case, the side rail 15R is preferably configured such that the distance in the vehicle width direction between the side rail 15R and the right side surface of the electric drive unit 11 increases from the portion of the right side surface to which the connector 16 is connected toward the rear of the vehicle 10.

Components other than the motor of the electric drive unit 11 may be changed as appropriate. For example, the speed reduction / differential mechanism may be omitted, or an electric device such as an inverter may be provided.

The dimensions and shapes of the suspension member 14 and the side rails 15L, 15R thereof may be appropriately changed from the illustrated shapes and dimensions.

For example, the electric vehicle 10 may be configured as a rear-drive battery-powered vehicle in which the rear wheels 13 are driven by the electric drive unit 11, or may be configured as a four wheel-drive hybrid electric vehicle or battery-powered vehicle in which the front wheels are driven by one or both of an engine and a motor.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuitry are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. An electric vehicle comprising:
an electric drive unit mounted at a rear portion of a vehicle, the electric drive unit being coupled to a rear wheel via a drive shaft;
a connector of a high-voltage cable connected to a portion of a side surface of the electric drive unit that is farther toward a rear of the vehicle than the drive shaft is; and
a side rail of a suspension member provided between the side surface and the rear wheel,
wherein the side rail is configured such that a distance in a vehicle width direction between the side rail and the side surface increases from a portion of the side surface to which the connector is connected toward the rear of the vehicle.
